(19) United States
(12) Patent Application Publication
(10) Pub. No.: US 2014/0016188 A1
(43) Pub. Date: Jan. 16, 2014

(54) Lens System

(71) Applicants: Asia Optical International Ltd., Tortola (GB); Sintai Optical (Shenzhen) Co., Ltd., Shenzhen City (CN)

(72) Inventor: Hsing-Ya Liu, Taichung (TW)

(21) Appl. No.: 13/922,298

(22) Filed: Jun. 20, 2013

(30) Foreign Application Priority Data
Jul. 11, 2012 (TW) 101124876

(51) Int. Cl. G02B 13/14

(52) U.S. Cl. CPC G02B 13/14
USPC 359/356

(57) ABSTRACT

A lens system includes a first lens. The first lens is an IR absorptive lens. The first lens includes a first surface facing the object side, and a second surface facing the image side.

### BACKGROUND OF THE INVENTION

1. Field of the Invention

The invention relates to a lens system, and more particularly to a lens system including an IR absorptive lens.

2. Description of the Related Art

A digital still camera, a digital video camera, or a mobile phone with photograph function generally includes a lens system and an image sensor (e.g. CCD or CMOS), wherein the lens system converges the light which is emitted from an object to the image sensor, and the image sensor receives and converts the light to electrical signals for subsequent processing. In addition to the visible signals which are emitted from the object, the image sensor is capable of sensing the infrared (IR) signals of wavelengths greater than 750 nm. As a result, the captured image is susceptible to color aberration arising from the infrared signals. The image quality is seriously affected.

A known method of eliminating the above-mentioned color aberration caused by the infrared lights is shown in FIG. 1, wherein an IR cut filter is disposed between the lens system and the image sensor for filtering out the uncalled-for infrared signals. FIG. 1 is a diagram for illustrating the known lens system for a mobile phone. The lens system 1 for a mobile phone includes a first lens 11, a second lens 12, a third lens 13 and an IR cut filter 14, all of which are arranged in sequence from an object side to an image side. The light emitted from the object side is directed toward the known lens system 1 of the mobile phone, passes through the first lens 11, the second lens 12, the third lens 13 and the IR cut filter 14 in sequence, and is converged to the image sensor 17 for imaging. The IR cut filter 14 allows the visible light rather than the infrared light from the object to pass through, thereby avoiding the image sensor from receiving the infrared signals to obtain a good image.

The above-mentioned method can correct color aberration caused by infrared light. However, the transmission spectrum of the IR cut filter shifts to shorter wavelengths when the incident angle of the incident beam increases. The greater the incident angle of the incident beam is, the more the transmission spectrum of the IR cut filter shifts. A zero-degree beam 15 and a twenty-six-degree beam 16 are shown in FIG. 1 for exemplary description, wherein the angle between the zero-degree beam 15 and the optical axis OA is 0 degrees, and the angle between the twenty-six-degree beam 16 and the optical axis OA is 26 degrees. The transmission spectrum for the two beams 15 and 16 passing through the lens system 1 of the mobile phone is shown in FIG. 2 wherein the horizontal axis represents the wavelength (in unit of nm) and the vertical axis represents the transmission rate (in unit of %). As shown, the transmission spectrum for the twenty-six-degree beam 16 significantly deviates from the transmission spectrum for the zero-degree beam 15 and shifts to shorter wavelengths. In addition, the beams 15 and 16 significantly differ from each other in the average transmission rate in the visible range (420 nm-680 nm), and there is a part of infrared light as shown in the infrared range (750 nm-1200 nm) able to pass through the IR cut filter 14. Thus, the color aberration, ghost image, and infrared noise cannot be completely eliminated, so as to affect the image quality.

### BRIEF SUMMARY OF THE INVENTION

The invention provides a lens system to solve the above problems. The lens system includes an IR cut lens. One surface of the IR cut lens is coated with an IR cut thin film and the other surface of the IR cut lens is coated with an antireflection coating. Such an arrangement is capable of lessening the shift of the transmission spectrum to shorter wavelengths when an incident beam enters the lens system at a large incident angle, reducing the differences between all incident beams in the average transmission rate in the visible range (420 nm-680 nm), and reducing the average transmission rate for all incident beams in the infrared range (750 nm-1200 nm), so as to reduce color aberration and ghost image, eliminate infrared noise and improve the image quality. In addition, the invention does not use an IR cut filter, thus saving the cost of an IR cut filter as well as shortening the length of the lens system.

The lens system in accordance with an exemplary embodiment of the invention includes a first lens that is an IR absorptive lens, wherein the first lens includes a first surface facing an object side and a second surface facing an image side.

In another exemplary embodiment, the curvature of the second surface is smaller than the curvature of the first surface.

In yet another exemplary embodiment, the first lens further includes an IR cut thin film that is coated on the second surface.

In another exemplary embodiment, the first lens further includes an antireflection coating that is coated on the first surface, or the first lens further includes an IR cut thin film that is coated on the first surface, or the first lens further includes an antireflection coating that is coated on the second surface.

In yet another exemplary embodiment, the first lens is made of blue glass.

In another exemplary embodiment, the lens system further includes a second lens, wherein the first lens and the second lens are arranged in sequence from the object side to the image side.

In yet another exemplary embodiment, the second lens is made of plastic material or glass material.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a schematic diagram for illustrating a known lens system for a mobile phone;

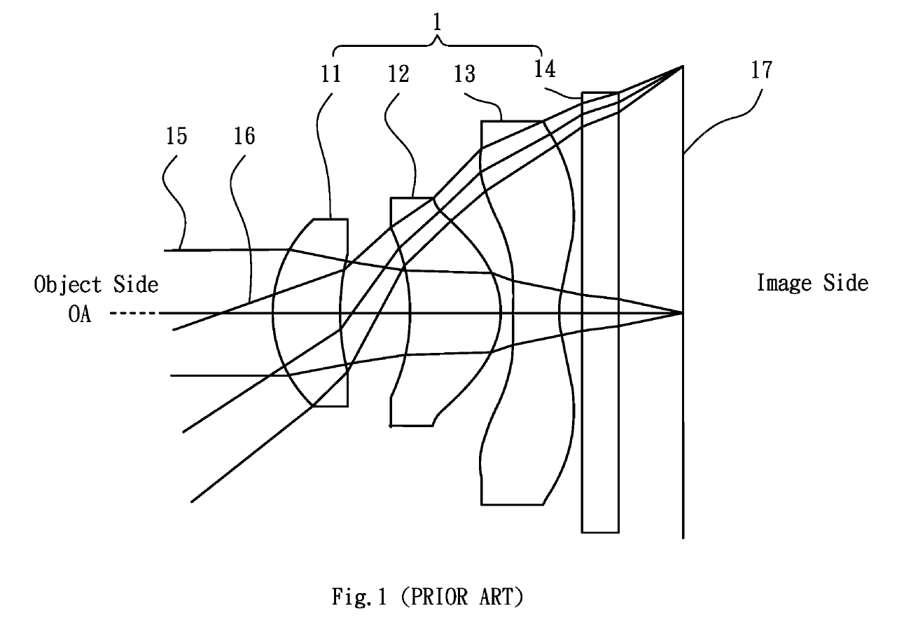

FIG. 2 is a transmission spectrum for a zero-degree beam and a twenty-six-degree beam entering the known lens system for the mobile phone lens;

FIG. 3 is a schematic diagram of a lens system in accordance with an embodiment of the invention; and

FIG. 4 is a transmission spectrum for a zero-degree beam and a twenty-six-degree beam entering a lens system in accordance with an embodiment of the invention.

### DETAILED DESCRIPTION OF THE INVENTION

The following description is made for the purpose of illustrating the general principles of the invention and should not be taken in a limiting sense. The scope of the invention is best determined by reference to the appended claims.

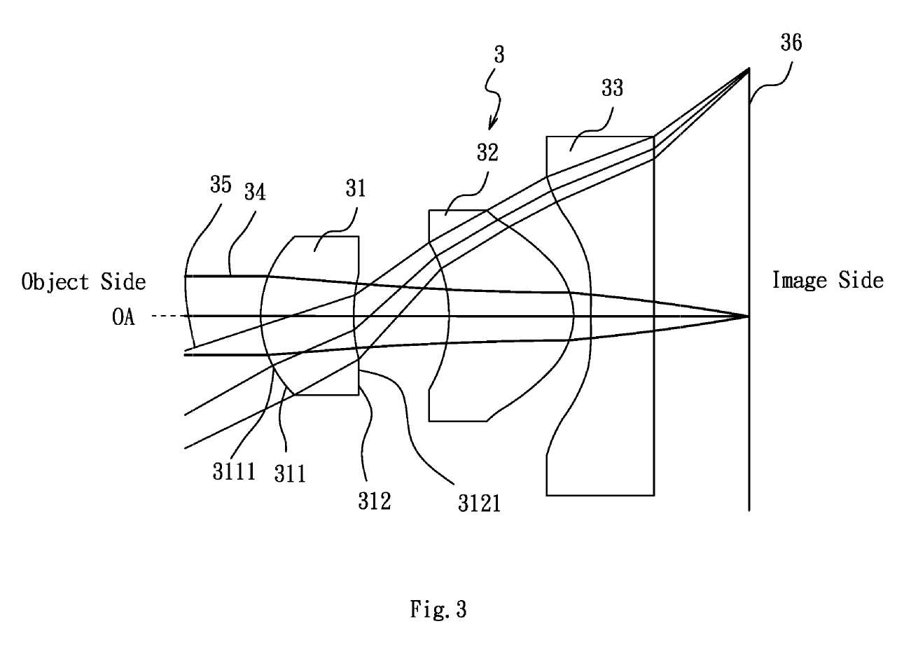

Referring to FIG. 3, FIG. 3 is a schematic diagram of a lens system in accordance with an embodiment of the invention. The lens system 3 includes a first lens 31, a second lens 32 and a third lens 33. The first lens 31 includes a first surface 311 and a second surface 312. The first surface 311 faces the object side. The second surface 312 faces the image side. The first surface 311 is coated with an antireflection coating 3111. The second surface 312 is coated with an IR cut thin film 3121. The light emitted from the object side is directed toward the lens system 3 and passes through the first lens 31, the second lens 32 and the third lens 33 in sequence, and finally converges to the image sensor 36 for imaging. The image sensor 36 receives and converts the light to electrical signals for subsequent processing.

The first lens 31 is made of material that can absorb infrared light. For example, the first lens 31 is an IR absorptive lens that is made of blue glass, allows visible of the incident light to pass through, and absorbs infrared of the incident light, thereby avoiding the image sensor from receiving infrared noise. The IR cut thin film 3121 is capable of reducing the shift of the transmission spectrum to shorter wavelengths when the incident beam enters the lens system 3 at a large angle, whereby the color aberration is reduced, the infrared light which is not absorbed by the first lens 31 is filtered out, and the infrared noise is significantly eliminated. The antireflection coating 3111 is capable of reducing the differences between all incident beams in the average transmission rate in the visible range (420 nm-680 nm), thereby reducing the ghost image.

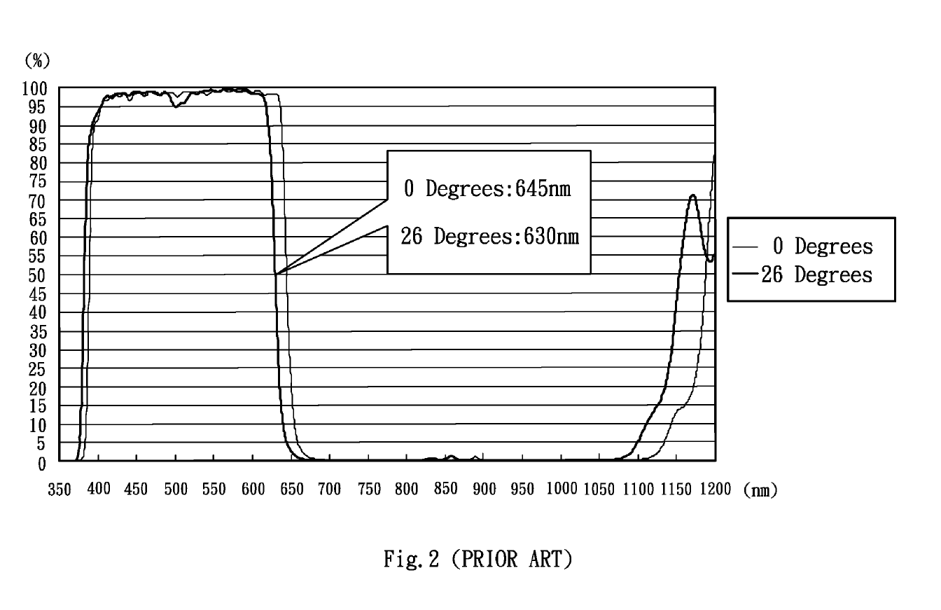

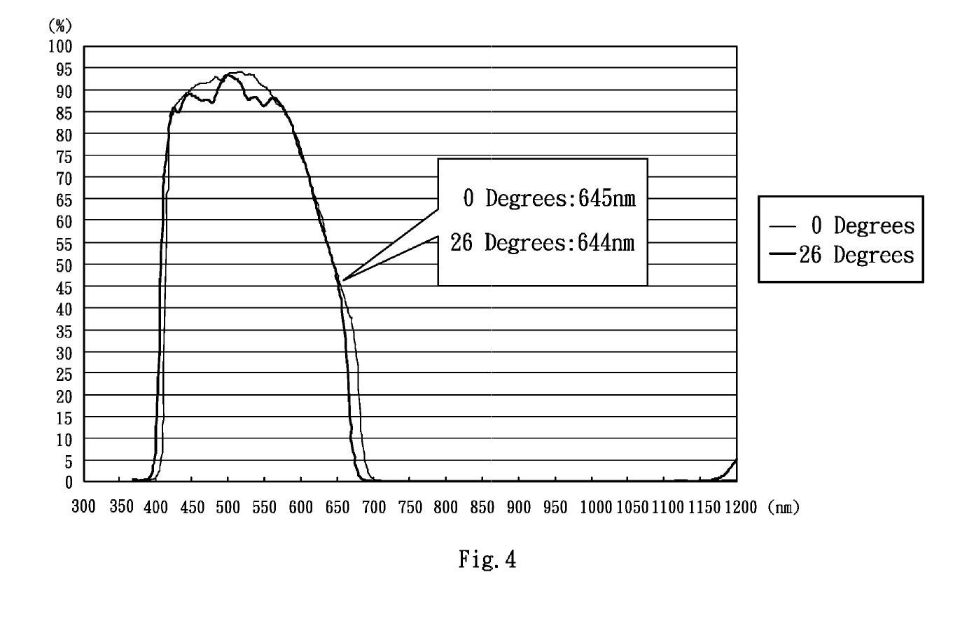

The advantage of the lens system of the invention is described by using the test data shown in FIG. 2 and FIG. 4. FIG. 2 is the transmission spectrum of a known lens system for a mobile phone for a zero-degree beam and a twenty-six-degree beam. FIG. 4 is the transmission spectrum of a lens system of the invention for a zero-degree beam and twenty-six-degree beam. In FIG. 4, the full-width at half-maximum (FWHM) of the transmission spectrum for the zero-degree beam and twenty-six-degree beam are respectively 645 nm and 644 nm, with 1 nm difference therebetween. In FIG. 2, however, the full-width at half-maximum of transmission spectrum for the zero-degree beam and twenty-six-degree beam are respectively 645 nm and 630 nm, with 15 nm difference therebetween. Obviously, the result of FIG. 4 is superior to that of FIG. 2. Thus, the color aberration generated by using the lens system of the invention is smaller than that generated by using the known lens system for the mobile phone.

The average transmission rates for the zero-degree beam and twenty-six-degree beam in the visible range (420 nm-680 nm) are respectively 78% and 75%, and the variation value is 3%, as shown in FIG. 4. The average transmission rates for the zero-degree beam and twenty-six-degree beam in the visible range (420 nm-680 nm) are respectively 86% and 79%, and the variation value is 7%, as shown in FIG. 2. Similarly, the result of FIG. 4 is superior to that of FIG. 2. Thus, the ghost image generated by using the lens system of the invention is smaller than that generated by using the known lens system for the mobile phone.

The average transmission rates for the zero-degree beam and the twenty-six-degree beam in the infrared range (750 nm-1200 nm) are respectively 0.73% and 0.16%, as shown in FIG. 4. The average transmission rates for the zero-degree beam and the twenty-six-degree beam in the infrared range (750 nm-1200 nm) are respectively 4.2% and 8.8%, as shown in FIG. 2. Obviously the result of FIG. 4 is superior to that of FIG. 2. Thus, the ability of eliminating infrared noise by using the lens system of the invention is superior to that of the known lens system for a mobile phone.

As described, the invention is capable of enhancing the image quality. It is also understood that an infrared cut filter is not included in the lens system of the invention. Thus, the cost of infrared cut filter can be saved and the length of the lens system can be shortened.

In FIG. 3, the lens system 3 includes three pieces of lenses. However, it is understood that other number of lenses (one, two, four or more) can be implemented and still falls into the scope of the invention.

In the above embodiment of the lens system for a mobile phone, the first lens 31 is made of blue glass, the second lens 32 is made of plastic or glass, and the third lens 33 is made of plastic or glass. However, it is understood that the invention is not limited to this embodiment. The material of each lens can be changed, depending on the practical situations.

The surface curvature of the lens is smaller (flatter), uniformly coating the IR cut thin film 3121 on the lens surface is easier. In the above embodiment, the curvature of the second surface 312 is smaller than that of the first surface 311. Therefore, the antireflection coating 3111 is coated on the first surface 311 and the IR cut thin film 3121 is coated on the second surface 312. However, it has the same effect and falls into the scope of the invention if the first surface 311 is coated with the IR cut thin film 3121 and the second surface 312 is coated with the antireflection coating 3111.

While the invention has been described by way of examples and in terms of embodiments, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A lens system comprising:
a first lens, wherein the first lens is an IR absorptive lens and comprises a first surface facing an object side, and a second surface facing an image side.

2. The lens system as claimed in claim 1, wherein a curvature of the second surface is smaller than a curvature of the first surface.

3. The lens system as claimed in claim 2, wherein the first lens further comprising an IR cut thin film, the IR cut thin film is coated on the second surface.

4. The lens system as claimed in claim 3, wherein the first lens further comprising an antireflection coating, the antireflection coating is coated on the first surface.

5. The lens system as claimed in claim 2, wherein the first lens further comprises an IR cut thin film coated on the first surface.

6. The lens system as claimed in claim 5, wherein the first lens further comprising an antireflection coating coated on the second surface.

7. The lens system as claimed in claim 1, wherein the first lens is made of blue glass.

8. The lens system as claimed in claim 1 further comprising a second lens, wherein the first lens and the second lens are arranged in sequence from the object side to the image side.

9. The lens system as claimed in claim 8, wherein the second lens is made of plastic material.

10. The lens system as claimed in claim 8, wherein the second lens is made of glass material.
